(19) United States
(12) Patent Application Publication
(10) Pub. No.: US 2014/0293620 A1
(43) Pub. Date: Oct. 2, 2014

(54) LIGHT REFLECTOR

(71) Applicant: SEKISUI PLASTICS CO., LTD., OSAKA-SHI (JP)

(72) Inventors: Tomohiro Mizuno, Tenri-shi (JP); Kengo Suzuki, Tenri-shi (JP); Kouji Yamada, Osaka-shi (JP)

(73) Assignee: SEKISUI PLASTICS CO., LTD., OSAKA-SHI (JP)

(21) Appl. No.: 14/227,367

(22) Filed: Mar. 27, 2014

(30) Foreign Application Priority Data
Mar. 29, 2013 (JP) 2013-073992

(51) Int. Cl. F21V 7/22; F21V 13/08

(52) U.S. Cl. CPC F21V 7/22; F21V 13/08
USPC 362/341

(57) ABSTRACT

The present invention provides a light reflector having a superior blue light-cutting property and superior light reflecting ability. Since the light reflector of the present invention is characterized by containing a thermoplastic resin and light reflective particulates, and by the total amount of the metal elements calcium, potassium, and magnesium being 150 to 1,000 μg/g, such has a superior blue light-cutting property; while controlling the reflection of light by absorbing light of the wavelength region of blue light, which is likely to have an adverse effect on human eyes, can effectively reflect visible light of other wavelength regions; and can reflect light so that light easy on the eyes is the reflected light.

### CROSS-REFERENCE TO RELATED APPLICATION

This application claims priority of Japanese Patent Application No.2013-73992 filed Mar. 29, 2013, which is incorporated herein by reference in its entirety.

### TECHNICAL FIELD

The present invention relates to a light reflector.

### BACKGROUND TECHNOLOGY

Conventionally, improvement in illuminance has been carried out by arranging a light reflector behind the light source of an illumination device, so as to increase the amount of light emitted from the light source. Also, liquid crystal display devices have been recently used in various uses as display devices, and in such liquid crystal devices, a backlight unit is arranged behind liquid crystal cells. The backlight unit includes a light source such as a cold-cathode tube or LEDs; a lamp reflector; a light guide plate; and a light reflector arranged on the back surface side of said light guide plate. This light reflector achieves the role of reflecting light which has leaked onto the back surface side of the light guide plate toward the liquid crystals cell side.

Moreover, the illumination device also has a light reflector provided behind the light source in order to effectively use light emitted from the light source.

Recently, liquid crystal display devices and illumination utilizing new light sources such as LEDs are in widespread use, and in light emitted from such light sources, a large amount of blue light, which is likely to have an adverse effect on human eyes, is included. Thus, a light reflector suppressing the reflection of light in the blue wavelength region (380 to 500 nm) (blue light-cutting property) while effectively reflecting visible light in other wavelength regions (500 to 780 nm) is desired.

As a light reflector, Patent Document 1 suggests a reflective film provided with an A layer containing a resin composition A comprising an aliphatic polyester-based resin or a polyolefin-based resin, and a microparticulate filler, the content ratio of said microparticulate filler in said resin composition A being 10 to 80% by mass, and at the same time provided with a B layer as the outermost layer of the side of the face used for reflection, containing a resin composition B comprising an aliphatic polyester-based resin or a polyolefin-based resin, and a microparticulate filler, the content ratio of said microparticulate filler in the resin composition B being greater than 0.1% by mass and less than 5% by mass.

### PRIOR ART DOCUMENTS

### Patent Documents

Patent Document 1: Japanese Patent No. 4041160

### SUMMARY OF THE INVENTION

### Problem to be Solved by the Invention

However, the reflective film of Patent Document 1 has the problem that the blue light-cutting property is inferior. The present invention provides a light reflector having a superior blue light-cutting property and superior light reflecting ability.

### Means for Solving the Problem

The light reflector of the present invention is characterized by containing a thermoplastic resin and light reflective particulates, and by having a total amount of the metal elements calcium, potassium and magnesium of 150 to 1,000 μg/g. Embodiments of the light reflector of the present invention include plate-like, sheet-like, and thermoformed-desired shapes.

As the synthetic resin forming the light reflector, there are particularly no limitations, and, for example, polyolefin-based resins, polyester-based resins, polystyrene-based resins, acrylic-based resins, polycarbonate-based resins, and the like can be mentioned. Polyolefin-based resins are preferable since a light reflector having superior moldability and chemical resistance, as well as superior flexibility can be obtained.

As polyolefin-based resins, there are particularly no limitations, and, for example, polyethylene-based resins, polypropylene-based resins, and the like can be mentioned. Polypropylene-based resins are preferable. The polyolefin-based resins may be used alone or by combining two or more thereof.

As the above-mentioned polyethylene-based resins, for example, low-density polyethylene, linear low-density polyethylene, high-density polyethylene, intermediate-density polyethylene, and the like can be mentioned.

Also, as the above-mentioned propylene-based resins, homopolypropylenes, ethylene-propylene copolymers, propylene-α-olefin copolymers, and the like can be mentioned. Furthermore, when the light reflector is a foamed sheet, a high-melt tension polypropylene-based resin disclosed in Japanese Patent No. 2521388 and Japanese Unexamined Patent Application, First Publication No. 2001-226510 is preferable as the polypropylene-based resin.

The ethylene-propylene copolymers and propylene-α-olefin copolymers may be either random copolymers or block copolymers. The amount of the ethylene component in the ethylene-propylene copolymers is preferably 0.5 to 30% by weight, and more preferably 1 to 10% by weight. Also, the amount of the α-olefin component in the propylene-α-olefin copolymers is preferably 0.5 to 30% by weight, and more preferably 1 to 10% by weight.

As α-olefins, α-olefins having a carbon number of 4 to 10 can be mentioned, and, for example, 1-butene, 1-pentene, 4-methyl- 1-pentene, 1-hexene, 1-heptene, 1-octene, and the like can be mentioned.

Among these, polypropylene-based resins are preferable as polyolefin-based resins. The below-mentioned light reflective particulates can be particularly finely dispersed in polypropylene-based resins.

The light reflector contains light reflective particulates. As the light reflective particulates, there are particularly no limitations as long as such can impart light reflecting ability to the light reflector through reflecting light incident on the light reflector. For example, synthetic light reflective particulates constituted from: metal particulates such as gold, silver, aluminum, nickel, and the like; metal oxide particulates such as titanium oxide (TiO₂), silicon oxide (SiO₂), aluminum oxide (Al₂O₃), and the like; an acrylic-based resin; a polystyrene-based resin; a copolymer of an acrylic-based monomer and a styrene-based monomer; and the like can be mentioned. Metal oxide particulates are preferable, and titanium oxide is more preferable.

Herein, “impart light reflecting ability to the light reflector through reflecting light incident on the light reflector” refers that “the diffused light reflectance of the light reflector with the light reflective particulates is higher than the reflectance of the light reflector without these particulates”. Both light reflectors have the same materials except for the existence of these particulates. The diffused light reflectance of the light reflector can be measured in accordance with JIS Z8722.

When the amount of light reflective particulates in the light reflector is too small, light reflecting ability of the light reflector may be insufficient. When the amount of light reflective particulates in the light reflector is too large, the mechanical strength of the light reflector may deteriorate or the light reflecting ability of the light reflector may deteriorate by poor dispersion of the light reflective particulates. Accordingly, the amount of light reflective particulates in the light reflector is preferably 1 to 100 parts by weight, and more preferably 5 to 50 parts by weight, with respect to 100 parts by weight of the thermoplastic resin.

The total amount of the metal elements calcium, potassium, and magnesium included in the light reflective particulates [total amount (μg) of the metal elements calcium, potassium, and magnesium included in 1 g of the light reflective particulates] is preferably 40 to 800 μg/g, more preferably 100 to 600 μg/g, and particularly preferably 300 to 600 μg/g. When the total amount of the metal elements calcium, potassium, and magnesium included in the light reflective particulates is too small, the blue light-cutting property of the light reflector may deteriorate, and also, when the metal elements exist as ions, aggregation among light reflective particulates arises more easily since the electrical repulsive force between light reflective particulates is reduced by the calcium, potassium, or magnesium included in the light reflective particulates. As a result, light reflecting ability of the light reflector may deteriorate or drawing down of the light reflector may occur at the time of molding by decrease in the melt tension of the thermoplastic resin comprising the light reflector. When the total amount of the metal elements calcium, potassium, and magnesium included in the light reflective particulates is too large, not only does the light reflecting ability of visible light in the necessary wavelength region (500 to 780 nm) deteriorate due to the too much absorption of light by the light reflective particulates, but stability of the light reflective particulates may deteriorate by reaction with other impurities and the like included in the light reflector.

As control methods of the total amount of the metal elements calcium, potassium, and magnesium included in the light reflective particulates, the following methods can be mentioned. For example, in the case of titanium oxide, although a chlorine method and a sulfuric acid method are known as production methods of titanium oxide, titanium oxide having a large amount of metal elements can be produced through production by the sulfuric acid method. Also, the amount of the metal elements calcium, potassium, and magnesium included in the light reflective particulates can be reduced by washing the light reflective particulates using a cleaning agent such as water or an alcohol like ethanol.

Herein, blue light-cutting property means the capability of cutting light of the blue light region (380 to 500 nm) from light of the visible light region (380 to 780 nm). For example, this can be measured by the difference in diffused light reflectance of the blue light region (380 to 500 nm) and the other visible light region (500 to 780 nm), and it can be said that larger the difference, the higher the blue light-cutting property. Specifically, it can be measured by measuring the diffused light reflectance at 450 nm as an indicator of the blue light region (380 to 500 nm) and the diffused light reflectance at 550 nm as an indicator of the other visible light region (500 to 780 nm), and then calculating the difference thereof.

The total amount of the metal elements calcium, potassium, and magnesium included in the light reflective particulates is measured in the following manner. Distilled water is supplied to a container having an internal volume of 50 ml. The inside of the container is washed by heating this distilled water at 70° C. for 2 hours. After about 0.5 g of a sample of light reflective particulates is supplied to the container, 10 ml of 5N hydrochloric acid is supplied and the resultant mixture is stirred for 10 minutes. Next, 20 ml of distilled water is further supplied to the container and the resultant mixture is stirred for a further 20 minutes. After filtering off the supernatant fluid in the container with an aqueous 0.45 μm chromatodisk, ICP measurement is carried out based on the sample obtained by filtering, the metal element concentration of each of calcium, potassium, and magnesium included in the light reflective particulates is measured, and the metal element amount is calculated based on the following equation.

Metal element amount (μg/g)=metal element concentration (μg/mp×30 (ml)/sample weight (g)

The total amount of the metal elements calcium, potassium, and magnesium included in the light reflective particulates can be calculated, for example with the following measurement apparatus under the following measurement conditions.
Measurement apparatus: Simultaneous Multi-Elemental Analysis ICP Emission Spectrometer ICPE-9000 manufactured by Shimadzu Corporation
Measured elements: Ca (317.933 nm), K (769.896 nm), Mg (285.213 nm)
Observation direction: axial direction, high-frequency output=1.20 kW, carrier flow rate=0.7 l/min, plasma flow rate=10.01/min, auxiliary flow rate=0.6 l/min, exposure time=30 sec
Calibration curve standard solution: XSTC-13 (general-purpose mixture standard solution) of USA SPEX, mixture of 31 elements (base: 5% HNO₃), each about 10 mg/l
Calibration curve preparation method: The above-mentioned standard solution is diluted stepwise with distilled water to prepare standard solutions respectively having concentrations of 0 ppm (BK), 0.2 ppm, 1 ppm, 2.5 ppm, and 5 ppm. The standard solution of each concentration is measured under the above-mentioned conditions and the peak strength of the wavelength of each element is obtained. The concentrations and peak strengths are plotted to obtain an approximation curve (linear or quadratic curve) by a least-squares method, and this is taken as the quantitative calibration curve.

When the average particle size of the light reflective particulates is too small, the light incident on the light reflector penetrates the light reflective particulates, and thus the light reflecting ability of the light reflector may deteriorate. When the average particle size of the light reflective particulates is too large, light incident on the light reflector is reflected by the light reflective particulates, which thus inhibits light attempting to be radiated to outside of the light reflector, and thus rather the light reflecting ability of the light reflector deteriorates. Accordingly, the average particle size of the light reflective particulates is preferably 0.1 to 0.39 μm, more preferably 0.13 to 0.35 μm, and particularly preferably 0.15 to 0.32 μm.

The average particle size of the light reflective particulates is measured in the following manner. That is, the light reflector is cut along the whole length in the thickness direction thereof, an enlarged screen is obtained by photographing the cut plane at a magnification of 2,500 times using a scanning electron microscope and a square-shaped measurement section in which one side is equal to 30 μm in the enlarged screen is set in an arbitrary portion on the enlarged screen. The diameter of the exact circle having the smallest diameter that can encompass the primary particle of each light reflective particulate in the measurement section is the particle size of the light reflective particulates, and the arithmetic average value of the particle size of each light reflective particulate is the average particle size of the light reflective particulates.

The light reflector can include additives such as flame retardants, ultraviolet absorbers, light stabilizers, stabilizers like antioxidants, and antistatic agents for preventing contamination, in a scope that such additives do not impair the physical properties thereof.

Furthermore, when the total amount of the metal elements calcium, potassium, and magnesium included in the entire light reflector [total amount (μg) of the metal elements calcium, potassium, and magnesium included in 1 g of ash of the light reflector] is too small, the blue light-cutting property of the light reflector may deteriorate. When the amount of the metal elements calcium, potassium, and magnesium included in the entire light reflector is too large, light incident on the light reflector is reflected by the light reflective particulates, which thus inhibits light attempting to be radiated to outside of the light reflector, and thus light reflecting ability of the light reflector deteriorates. Accordingly, the total amount of the metal elements calcium, potassium, and magnesium included in the entire light reflector is limited to 150 to 1,000 μg/g, and is preferably 200 to 900 μg/g, more preferably 300 to 800 μg/g, and particularly preferably 500 to 800 μg/g.

The total amount of the metal elements calcium, potassium, and magnesium included in the entire light reflector is referred to as the value measured in the following manner. An ash is obtained by carrying out an ashing process on the light reflector under the conditions of 450° C. for 3 hours. The amount of the metal elements calcium, potassium, and magnesium included in the obtained ash is measured in the same manner as when measuring the amount of the metal elements calcium, potassium, and magnesium included in the light reflective particulates. The ashing process of the light reflector can be carried out using an apparatus sold under the product name of “Electric Furnace Muffle Furnace STR-15K” from Isuzu Ltd., for example. Also, the total amount of the metal elements calcium, potassium, and magnesium included in the entire light reflector can be measured with the above-mentioned measurement apparatus and under the above-mentioned conditions that can be used when measuring the total amount of the metal elements calcium, potassium, and magnesium included in the light reflective particulates.

The metal elements calcium, potassium, and magnesium included in the entire light reflector covers, in addition to the metal elements derived from the light reflective particulates, all of metal elements included in the thermoplastic resin per se constituting the light reflector, metal elements included in the polymerization catalyst used when polymerizing the thermoplastic resin constituting the light reflector that remains in the thermoplastic resin, and metal elements included in additives added to the light reflector.

As adjustment methods of the total amount of the metal elements calcium, potassium, and magnesium included in the light reflector, for example, a method of adjusting the amount of light reflective particulates in the light reflector, a method of adjusting the amount of metal elements included in the light reflective particulates, a method of adjusting the amount of additives included in the light reflector, a method of adjusting the type of thermoplastic resin used in the light reflector, and the like can be mentioned.

Next, the production method of the light reflector is explained. The production method of the light reflector is not particularly limited, and, for example, a method of producing a light reflector in which a thermoplastic resin and light reflective particulates are supplied to an extruder so as to be melt-kneaded, and then extruded from a die attached to the extruder, and the like can be mentioned.

The light reflector may be foamed. When the light reflector is foamed, in the above-mentioned method, the physical blowing agent may be added to the extruder and then extrusion-foamed from the extruder.

As the physical blowing agent, there are no particular limitations, and, for example, saturated aliphatic hydrocarbons such as propane, normal butane, isobutane, normal pentane, isopentane, and hexane; ethers such as dimethyl ether; methyl chloride; carbon dioxide; nitrogen; and the like can be mentioned. Dimethyl ether, propane, normal butane, isobutane, and carbon dioxide are preferable; propane, normal butane, and isobutane are more preferable; and normal butane and isobutane are particularly preferable. The physical blowing agents may be used alone or by combining two or more thereof.

The light reflector of the present invention can be used for various applications such as light reflectors constituting backlight units of liquid crystal display devices for various devices such as word processors, personal computers, mobile phones, navigation systems, televisions and mobile televisions, and light reflectors constituting illumination devices.

### EFFECTS OF THE INVENTION

The light reflector of the present invention contains a thermoplastic resin and light reflective particulates, and has a total amount of the metal elements calcium, potassium, and magnesium of 150 to 1,000 μg/g. Accordingly, the light reflector of the present invention has a superior blue light-cutting property, and controls the reflection of light by absorbing light of the wavelength region of blue light (380 to 500 nm), which is likely to have an unfavorable effect on human eyes. The light reflector of the present invention effectively reflects visible light in other wavelength region (500 to 780 nm). Accordingly, the light reflector of the present invention can reflect light that is favorable on human eyes as reflected light.

In the above-mentioned light reflector, when the total amount of the metal elements calcium, potassium, and magnesium included in the light reflective particulates is 40 to 800 μg/g, the blue light-cutting property is further superior. When the metal elements exists as ions, aggregation of light reflective particulates by electrical repulsive force of metal elements included therein is prevented and the light reflective particulates can be dispersed in the thermoplastic resin without aggregation, and the light reflector has superior light reflecting ability.

Also, the light reflective particulates are dispersed in the thermoplastic resin without aggregation. Accordingly, the melt tension of the thermoplastic resin can be maintained high, and even when the light reflector is heated in order to thermoform into a desired shape, the light reflector can be accurately thermoformed without draw-down occurring in the light reflector.

The present invention is explained in further detail below by way of examples, but such is not limited to the present examples.

### BEST MODE FOR CARRYING OUT THE INVENTION

### Production of Titanium Oxide Master Batch (a)

60 parts by weight of titanium oxide (product name “JR403” manufactured by Tayca Corporation, average particle size: 0.25 μm) and 40 parts by weight of homopolypropylene (product name “PL500A” manufactured by SunAllomer Ltd., melt flow rate: 3.3 g/10 min, density: 0.9 g/cm³) were melt-kneaded at 230° C. in a vent-type double-screw extruder with a bore diameter of 120 mm, and pelletized to produce a titanium oxide master batch (titanium oxide MB) (a). When melt-kneading the titanium oxide and homopolypropylene in the cylinder of the vent-type double-screw extruder, gas in the cylinder is discharged to the outside from the vent opening by a vacuum pump so that the pressure in the cylinder becomes 60 mmHg (8 kPa).

### Production of Titanium Oxide Master Batch (b)

Other than using titanium oxide (product name “JR805” manufactured by Tayca Corporation, average particle size: 0.29 μm) as the titanium oxide, a titanium oxide MB (b) was prepared similar to the titanium oxide MB (a).

### Production of Titanium Oxide Master Batch (c)

Other than using titanium oxide (product name “R-32” manufactured by Sakai Chemical Industry Co., Ltd., average particle size: 0.20 μm) as the titanium oxide, a titanium oxide MB (c) was prepared similar to the titanium oxide MB (a).

### Production of Titanium Oxide Master Batch (d)

Other than using titanium oxide (product name “FTR-700” manufactured by Sakai Chemical Industry Co., Ltd., average particle size: 0.20 μm) as the titanium oxide, a titanium oxide MB (d) was prepared similar to the titanium oxide MB (a).

### Production of Titanium Oxide Master Batch (e)

Other than using titanium oxide (product name “CR-63” manufactured by Ishihara Sangyo Kaisha, Ltd., average particle size: 0.25 μm) as the titanium oxide, a titanium oxide MB (e) was prepared similar to the titanium oxide master batch MB (a).

The amounts of the metal elements calcium, potassium, and magnesium included in the titanium oxide that becomes a raw material used in the preparation of titanium oxide master batches (a) to (e) are shown in Table 1.

### EXAMPLES 1 to 4 AND COMPARATIVE EXAMPLE 1

A resin composition including 48 parts by weight of any one titanium oxide master batch among the titanium oxide master batches (a) to (e), 81 parts by weight of homopolypropylene (product name “PL500A” manufactured by SunAllomer Ltd., melt flow rate: 3.3 g/10 min, density: 0.9 g/cm³), 0.2 parts by weight of a phenol-based antioxidant (product name IRGANOX® 1010 manufactured by BASF), 0.2 parts by weight of a phosphorus-based antioxidant (product name IRGAFOS 168 manufactured by BASF), 0.15 parts by weight of a benzotriazole-based ultraviolet absorber (product name TINUVIN® 326 manufactured by BASF), and 0.15 parts by weight of a hindered amine-based light stabilizer (product name TINUVIN® 111 manufactured by BASF) were supplied to a vent-type single-screw extruder with an bore diameter of 120 mm, melt-kneaded at 220° C., and extruded into a sheet from a T-die (sheet width: 1,000 mm, distance between slits: 0.5 mm, temperature: 200° C.) attached to the head of the extruder to produce a non-foamed light reflector. The titanium oxide contained in the light reflector was 28.7 parts by weight with respect to 100 parts by weight of the homopolypropylene.

Next, the light reflector was supplied between a pair of rolls consisting of a mirror roll and a support roll disposed so as to face the mirror roll and cooled, so as to obtain a non-foamed light reflector having an entire thickness of 0.5 mm and a density of 1.09 g/cm³. When melt-kneading the resin composition in the cylinder of the vent-type single-screw extruder, gas in the cylinder is discharged to the outside from the vent opening by a vacuum pump so that the pressure in the cylinder becomes 60 mmHg (8 kPa).

Regarding the obtained light reflector, the diffused light reflectance at 450 nm and 550 nm was measured in the following manner, and amount of the metal elements calcium, potassium, and magnesium was measured in the above-mentioned manner. The results thereof are shown in Table 2.

### Diffused Light Reflectance

Regarding the obtained light reflector, in accordance with JIS Z8722, the diffused light reflectance was measured under vertical incidence conditions at 450 nm and 550 nm using an ultraviolet-visible light spectrophotometer (product name “UV-2450” manufactured by Shimadzu Corporation) and an integrating sphere attachment (product name “ISR-2200” manufactured by Shimadzu Corporation, inner diameter: 60 mm). A(550 nm-450 nm) was calculated by subtracting the value of diffused light reflectance at 450 nm from the value of diffused light reflectance at 550 nm. Diffused light reflectance shows the absolute value when diffused light reflectance using a barium sulfate plate as a standard reflector is 100.

TABLE 1

| | | | Amount of Metal | | | | Average |
|---|---|---|---|---|---|---|---|
| | | | Element (μg/g) | | | | Particle |
| | | | Ca | K | Mg | Total | Size (μm) |
| Titanium | a | JR403 | 57.6 | 176 | 10.2 | 243.8 | 0.25 |
| Oxide MB | b | JR805 | 33.8 | 219 | 10.9 | 263.7 | 0.29 |
| | c | R-32 | 85 | 27 | 449 | 561 | 0.20 |
| | d | FTR-700 | 236 | 171 | 111 | 518 | 0.20 |
| | e | CR-63 | 7.8 | 4.5 | 0 | 12.3 | 0.21 |

TABLE 2

| | Titanium | | Diffused Light Reflectance (%) | | | Amount of Metal Element (μg/g) | | | |
|---|---|---|---|---|---|---|---|---|---|
| | Oxide MB | | 450 nm | 550 nm | Δ(550 nm − 450 nm) | Ca | K | Mg | Total |
| Example 1 | a | JR403 | 96.6 | 97.8 | 1.2 | 189 | 227 | 52 | 468 |
| Example 2 | b | JR805 | 96.5 | 98.0 | 1.5 | 109 | 326 | 38 | 473 |
| Example 3 | c | R-32 | 94.5 | 98.3 | 3.8 | 169 | 35 | 546 | 750 |
| Example 4 | d | FTR-700 | 96.0 | 98.0 | 2.0 | 274 | 199 | 182 | 655 |
| Comparative | e | CR-63 | 97.6 | 98.1 | 0.5 | 104 | 8 | 23 | 135 |
| Example 1 | | | | | | | | | |

1. A light reflector that contains a thermoplastic resin and light reflective particulates, and that has a total amount of metal elements calcium, potassium, and magnesium of 150 to 1,000 μg/g.

2. The light reflector according to claim 1, wherein the total amount of metal elements calcium, potassium, and magnesium is 40 to 800 μg/g.

3. The light reflector according to claim 1, wherein an average particle size of the light reflective particulates is 0.1 to 0.39 μm.

4. The light reflector according to claim 1, wherein the light reflective particulates are titanium oxide.

5. The light reflector according to claim 2, wherein an average particle size of the light reflective particulates is 0.1 to 0.39 μm.

6. The light reflector according to claim 2, wherein the light reflective particulates are titanium oxide.
